(19) United States
(12) Patent Application Publication
(10) Pub. No.: US 2012/0268728 A1
(43) Pub. Date: Oct. 25, 2012

(54) GEM POSITIONING AND ANALYSIS SYSTEM

(75) Inventors: Randall Wagner, Mequon, WI (US); Kurt P. Schoeckert, Hartford, WI (US)

(73) Assignee: GemEx Systems, Inc., a Wisconsin corporation, Mequon, WI (US)

(21) Appl. No.: 13/277,912

(22) Filed: Oct. 20, 2011

Related U.S. Application Data
(60) Provisional application No. 61/477,267, filed on Apr. 20, 2011.

(51) Int. Cl. G01N 21/01

(52) U.S. Cl. 356/30

(57) ABSTRACT

A gemstone positioning and analysis system is disclosed for measuring various characteristics of a gemstone. The system includes a narrow band spectrophotometer that allows the authenticity of the gemstone to be determined along with other characteristics of the gemstone. A clear mounting plate is also included that has a series of markings to facilitate centering the gemstone within an analysis chamber. An alignment device is included that has at least one linear pusher and is adapted to automatically center the gemstone at the centermost point of the clear mounting plate.

### CROSS-REFERENCE TO RELATED APPLICATION

This application is based on and claims priority from U.S. Provisional Patent Application No. 61/477,267 filed on Apr. 20, 2011, which is incorporated herein by reference in its entirety for all purposes.

### FIELD OF THE INVENTION

The present invention relates generally to the field of gemstone evaluation systems. More particularly, the present invention relates to a gemstone evaluation system with the added feature of automatic centering of a gemstone and the addition of a narrow band spectrophotometer to determine the authenticity of the gemstone.

### BACKGROUND

The commercial value of a gemstone depends on a number of factors, including weight, cut, clarity, color, and, perhaps most importantly, the authenticity of the gemstone. Traditionally, evaluating those and other such characteristics was the job of highly trained specialists, known as “graduate gemologists.” Recently, a number of computer controlled machines have been developed to perform many of the same functions as graduate gemologists. The machines are more consistent and precise when it comes to measuring minute details and features present in gemstones. In particular, the machines are used to evaluate differences in color that are imperceptible to even the highly trained eye of a graduate gemologist. One such machine is described in U.S. Pat. No. 5,615,005, which is incorporated herein by reference in its entirety for all purposes.

Machines like the one described in U.S. Pat. No. 5,615,005 typically include a light source, optical band pass filter, camera or wide band spectrophotometer, and analysis chamber. An operator places the gemstone in the observation chamber, and light from the light source is sent through the band pass filter such that a specific wavelength of light illuminates the gemstone. The light source may also be manipulated so that the beam of light illuminates the gemstone from varying angles, thus performing the same test as a gemologist would perform manually. The cameras that are currently used in gemstone evaluation machines are typically Charged Coupled Device (CCD) cameras or wide band spectrophotometers. These cameras are an improvement over the human eye, but cannot detect the difference between a diamond or a cubic zirconium, for example. Rather, the cameras currently used in gemstone evaluation machines can only determine where the gemstone falls on a color/clarity scale. To determine whether a gemstone such as a diamond is authentic (not man or machine made), a separate test must be performed, often in a separate lab. The separate test may involve narrow-band spectrophotometry, which is targeted to a range of wavelengths known in the art, typically with a scanning band 1-3 nm wide.

### SUMMARY

The present invention relates to a gemstone positioning and analysis system for measuring characteristics of a gemstone that includes a cabinet having an analysis chamber adapted to receive the gemstone. The analysis chamber has upper and lower hemispherical portions with a mounting plate between the hemispherical portions. The hemispherical portions each have reflective inner surfaces. The lower hemispherical portion has an aperture at its lowermost point that is adapted to allow light to pass into the analysis chamber. The clear mounting plate includes a series of markings to facilitate centering the gemstone within the analysis chamber. An alignment device is included that has at least one linear pusher and is adapted to automatically center the gemstone at the centermost point of the clear mounting plate. A movable light source is adapted to illuminate the gemstone from a plurality of angles, and a camera is adapted to record images of the gemstone. The camera is further adapted to provide data to a computer system that analyzes the data and outputs the material characteristics of the gemstone.

The gemstone evaluation system of the present invention includes the automatic positioning of a gemstone and a narrow band spectrophotometer (“NBS”), which allows the machine to detect material characteristics of the gemstone such as whether it is natural or man-made. The automatic positioning function solves the problem of an operator inaccurately placing a gemstone on the observation plane, which can result in erroneous test results. The addition of an NBS also allows a user to simultaneously perform the tests of the current system and the additional tests that are now performed by a secondary process. Performing the tests together greatly decreases the likelihood of fraud or deception that, regrettably, is possible when the tests are performed separately, often in different labs. After the analysis is complete, a user is provided a report showing the characteristics of the gemstone, including the results of the narrow-band spectrophotometer analysis, along with a picture of the gemstone. Such a report virtually eliminates the opportunity for deception that currently exists.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF DESCRIPTION OF THE DRAWINGS

FIG. 1 is a perspective view of one embodiment of a gemstone evaluation system in accordance with the invention.

FIG. 2 is a perspective view of a gemstone positioning actuator in accordance with the gemstone evaluation system of FIG. 1, with the actuator in an open position.

FIG. 3 is another perspective view of the gemstone positioning actuator of FIG. 2, with the actuator in an extended position.

FIG. 4 is a top detail view of the gemstone positioning actuator of FIG. 2 with the actuator in position engaging the gemstone.

FIG. 4A is another top detail view of the gemstone positioning actuator of FIG. 2 with the actuator disengaged from the gemstone.

FIG. 5 is another top detail view of the gemstone positioning actuator of FIG. 2 with the actuator in a centered position.

FIG. 6 is a perspective view of another embodiment of a gemstone evaluation system in accordance with the invention.

FIG. 7 is a perspective view of a gem positioning actuator in accordance with the gemstone evaluation system of FIG. 6, with the actuator in a retracted position.

FIG. 8 is a perspective view of a gem positioning actuator in accordance with the gemstone evaluation system of FIG. 6, with the actuator in an extended position.

FIG. 9 is a perspective view of another embodiment of a gemstone positioning actuator is accordance with the present invention with the actuator in an open position.

FIG. 9A is a top detail view of the gemstone positioning actuator of FIG. 9 engaging the gemstone.

FIG. 10 is another perspective view of the gemstone positioning actuator of FIG. 9, with the actuator in a closed position.

FIG. 10A is a top detail view of the gemstone positioning actuator of FIG. 10.

### DETAILED DESCRIPTION

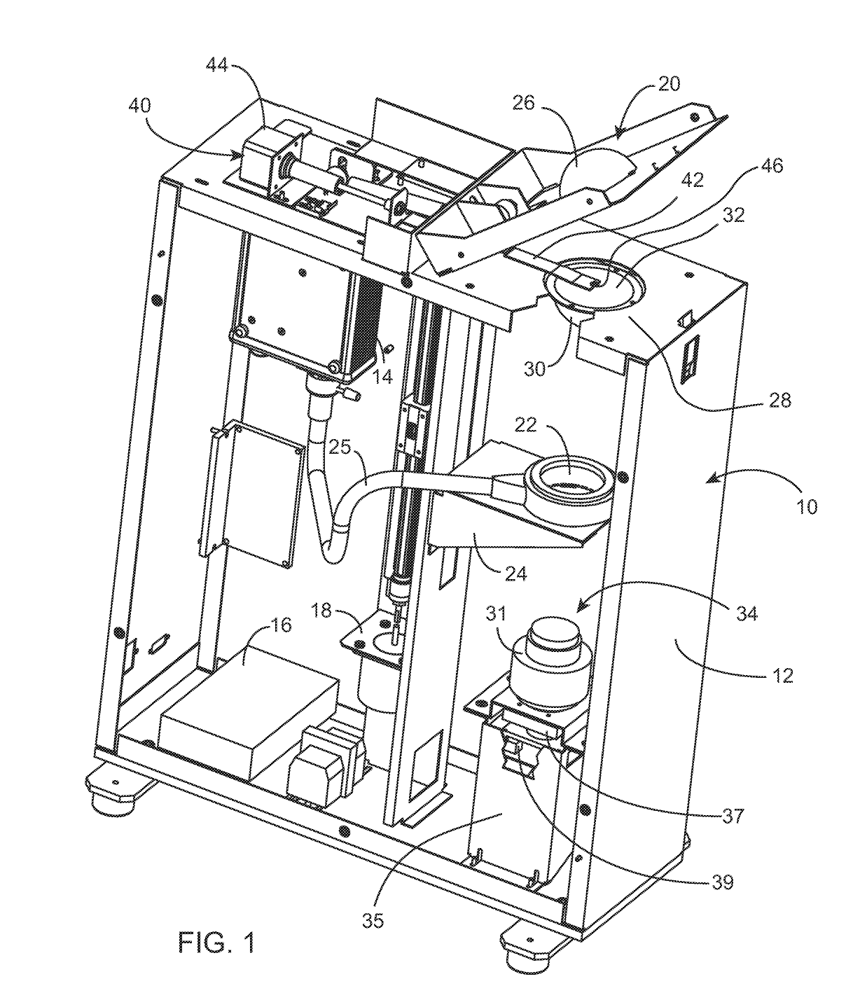

Turning now to FIG. 1, a perspective view of the gemstone color evaluation system or device 10 constructed in accordance with the present invention is shown. The device 10 includes an illuminating and signal capturing cabinet 12.

The cabinet 12 contains a light source 14 and a control system 16. The control system 16 controls a light motion system 18. The cabinet 12 further includes an analysis chamber 20, and an annular light ring 22. The annular light ring 22 is mounted to a platform 24 moved by the light motion system 18. Light ring 22 may be illuminated in a variety of ways, but in the embodiment shown, light is conveyed from the light source 14 to the annular light ring 22 by means of a fiber optic connector 25.

Analysis chamber 20 is a two-piece unit including an upper hemispherical member 26 and a partial lower hemispherical member 28, forming a sphere, with a reflective coating on the inside of upper member 26 and lower member 28. A single entry/exit aperture 30 is formed in the lowest part of the lower member. The entry/exit aperture 30 is of adequate size to allow light to enter the analysis chamber 20, and for a CCD camera assembly 34 to be able to view the gemstone 46 in the analysis chamber 20, yet small enough that light is effectively reflected within the analysis chamber 20 to provide accurate test results. Centered in the chamber is a glass plate 32 on which a gemstone to be evaluated is placed tableside down. Tableside down orientation is preferred because currently gemstones are graded by refracted light through the table of the gemstone. Although glass is preferred, other clear, transparent materials may be used, in any supporting structure. Etched or otherwise marked onto the glass plate 32 is a pattern 33 that allows the system to accurately measure the size and location of the gemstone 46 at any given time. In the embodiment shown, the pattern 33 is a bulls-eye pattern, but any suitable pattern could be used without deviating from the invention. At the center of the pattern 33 is a center point 36.

The light motion system 18 is configured to move the annular light ring 22 such that as the platform 24 moves, the light from the annular light ring 22 illuminates a gemstone 46 from a range of angles. Gemstones are generally viewed by gemologists from multiple angles, relative to light sources, to obtain the quality and color of a gemstone. The multiple position light source provides the device with the same capabilities.

Directly below the annular light ring 22 is located a CCD camera assembly 34, which includes a fixed focal length lens 31, a band pass filter 37, and a CCD camera 39. The CCD camera assembly 34 is oriented to be aimed at the center of the analysis chamber 20. The centerlines of the analysis chamber 20, annular light ring 22, and CCD camera assembly 34 are intended to be common. The CCD camera assembly 34 is used to both analyze the quality and color of the gemstone 46, but is also used to accurately position the gemstone 46 such that the centerline of the gemstone 46 is also common with the centerlines of the analysis chamber 20, annular light ring 22, and CCD camera assembly 34.

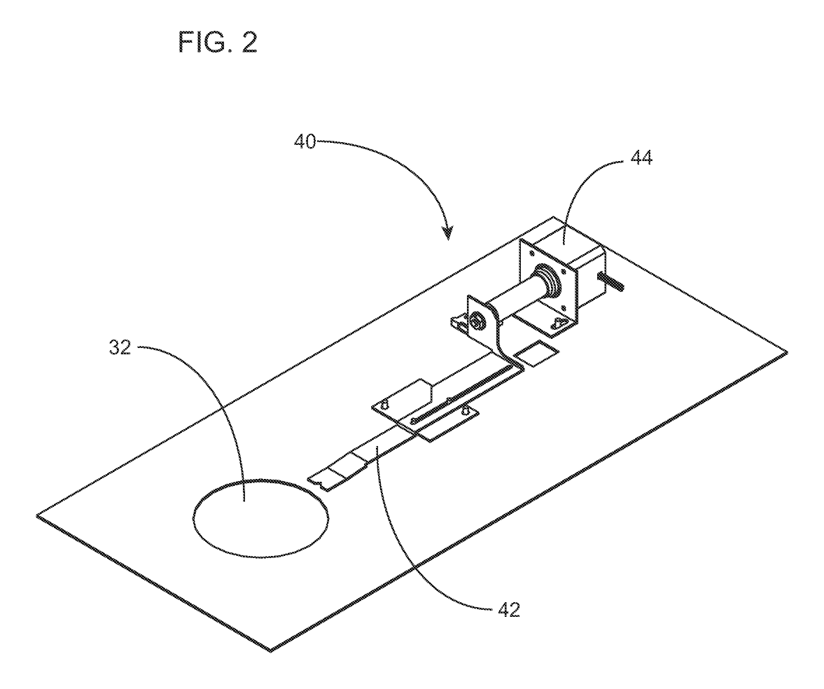

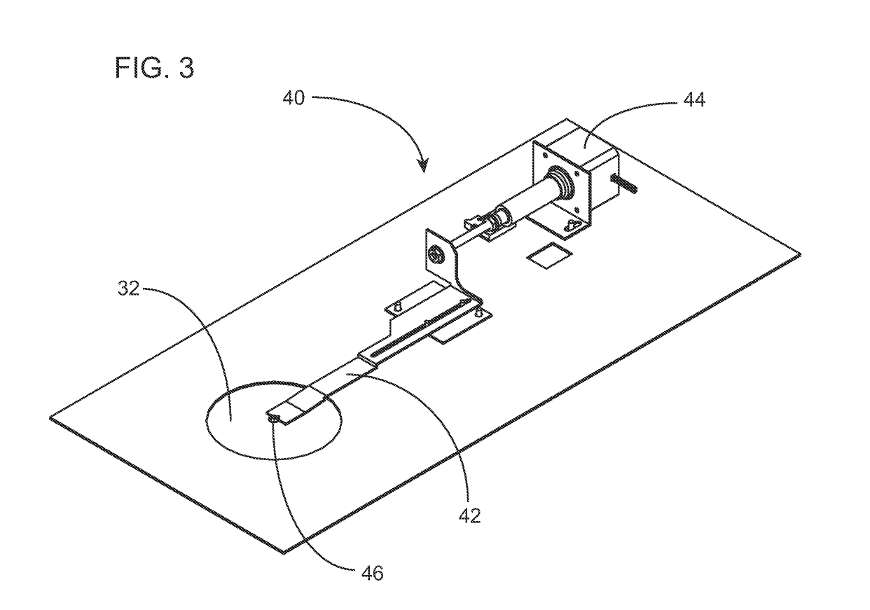

An alignment device 40 is adapted to automatically align the gemstone with that common centerline, without the necessity of the operator locating that centerline and attempting to manually align the gemstone's centerline with it simply by hand placement of the gemstone. The alignment device 40 includes a pusher member 42, operated by a linear actuator 44, in turn connected to and controlled by the control system 16. FIG. 2 shows the pusher member 42 in the retracted position, and FIG. 3 shows the pusher member 42 in the extended position.

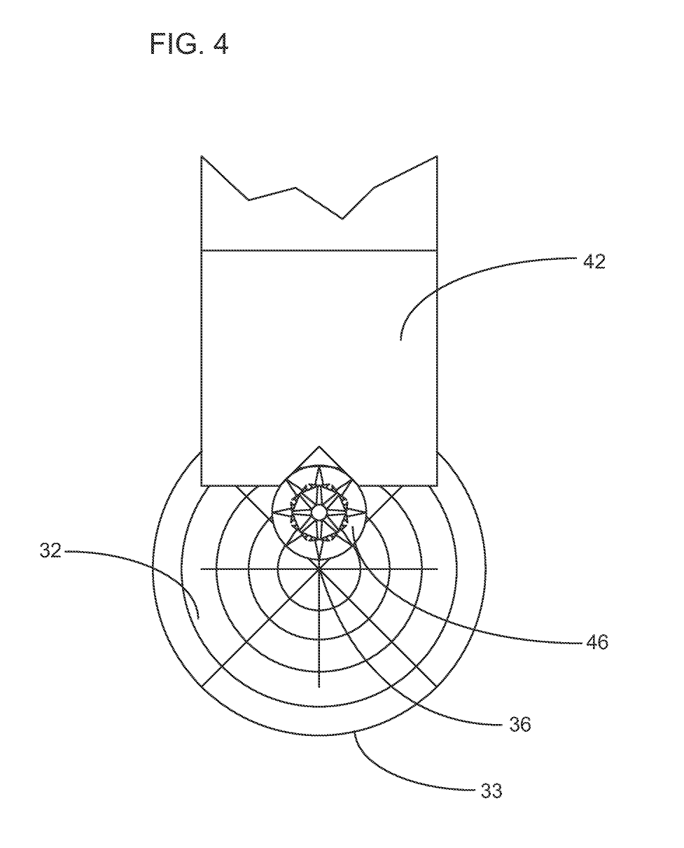

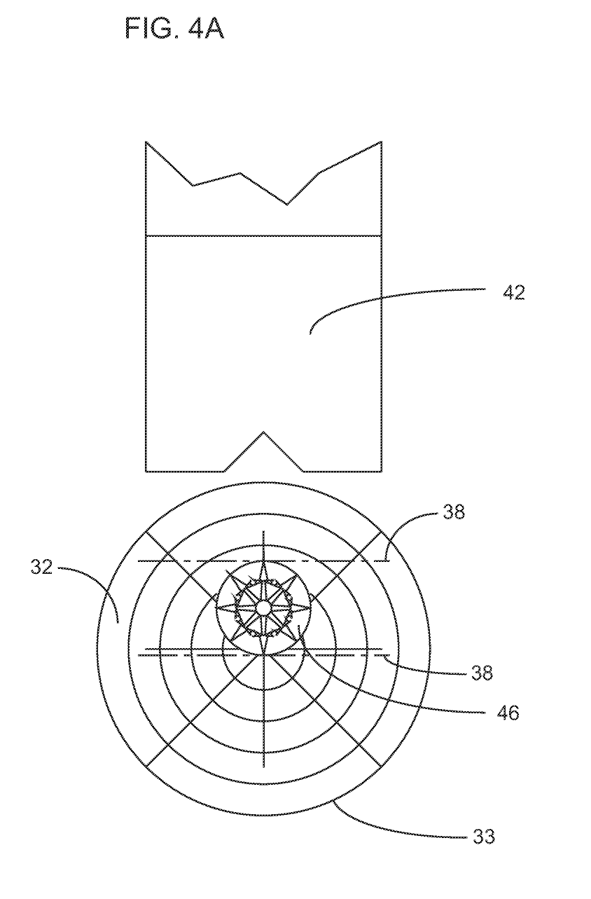

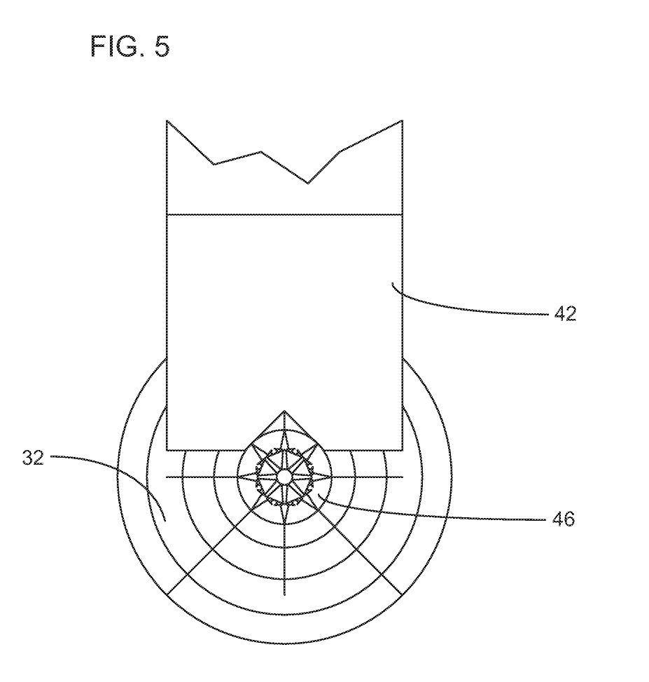

As shown in FIGS. 4-5, a gemstone 46 is placed on the glass plate 32, and the aligning device 40 is actuated such that the linear actuator 44 that is connected to the pusher member 42 extends, so that the pusher member becomes engaged with the gemstone 46, moving it slightly. The pusher member 42 then retracts, disengaging with the gemstone 46. By moving the pusher member 42 away from the gemstone 46, software included in the invention uses the CCD camera assembly 34, which is part of a computer imaging system 35, to measure the diameter of the gemstone 46 as well as how far the gemstone 46 is offset from the centerline. The computer imaging system 35 measures the diameter of the gemstone 46 by sensing the outer edge of the gemstone 46 and creating virtual tangential lines 38 on opposite sides of the gemstone 46. With the diameter calculated, the system can then determine how far the center point of the gemstone 46 is from the center point 36 of the pattern 33 on the glass plate 32. Upon completing the measurement, the aligning device 40 extends the pusher member 42, re-engaging with the gemstone 46 and moving the gemstone into alignment with the centerline. FIG. 4 shows the gemstone 46 in a position not on the centerline, FIG. 4A shows the pusher member 42 disengaged from the gemstone 46, and FIG. 5 shows the pusher member 42 having moved the gemstone 46 to the centerline. Thus, the automatic positioning is achieved by using the computer imaging system 35 to “see” the gemstone 46 on the glass plate 32.

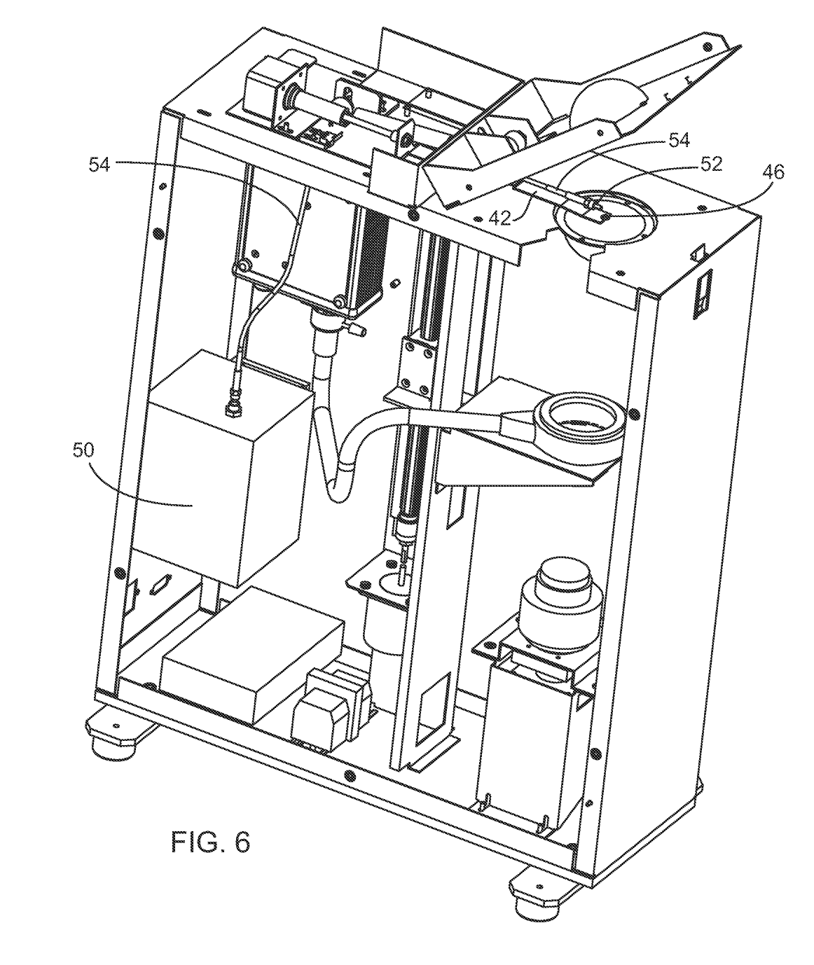

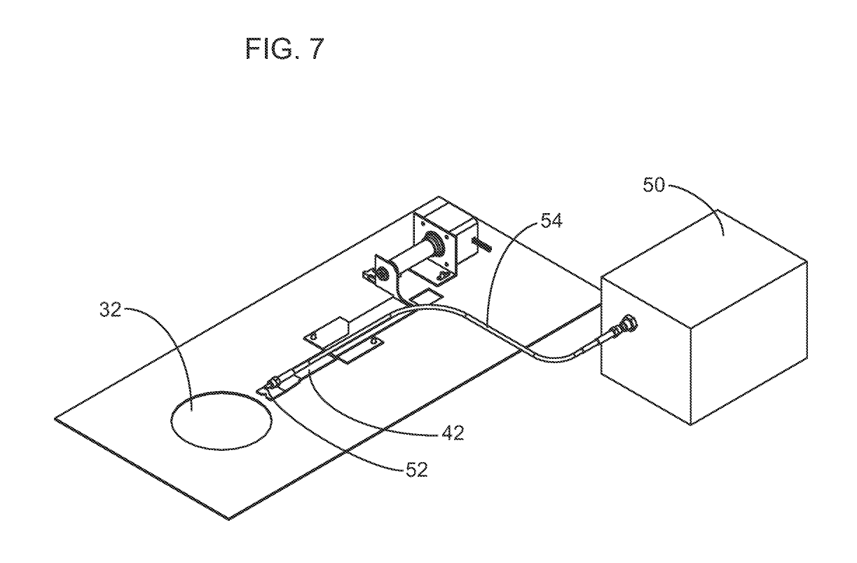

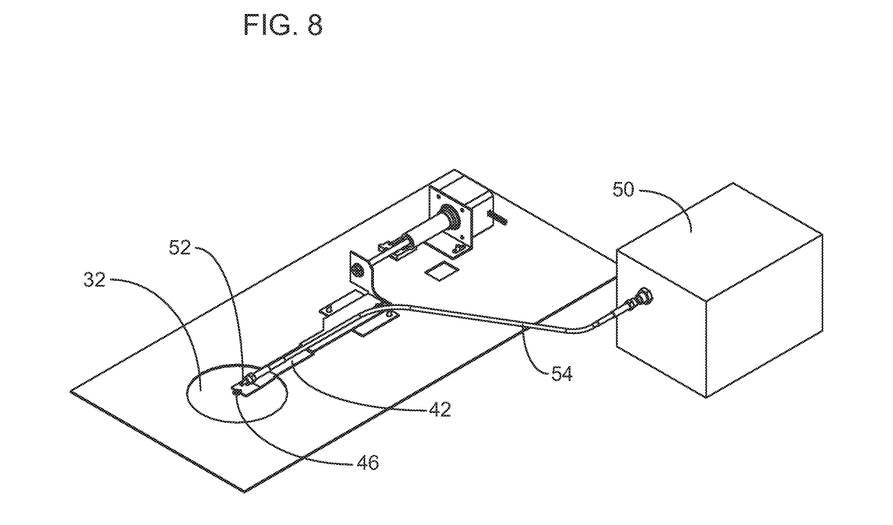

Turning now to FIG. 6, a further improvement is shown wherein a narrow band spectrophotometer (“NBS”) 50 is added inside the cabinet 12. A probe 52 is preferably mounted to the pusher member 42 so as to be positioned sufficiently closely to the gemstone 46, and is connected to the NBS 50 by a fiber optic connector 54 so as to enable the NBS 50 to analyze the gemstone. FIGS. 7 and 8 show a schematic arrangement of the NBS 50, connector 54 and probe 52. The NBS in the embodiment shown is a scanning NBS, that generates an output over a range of frequencies. The software then analyzes the output of the NBS for peaks, which indicate that a specific wavelength of light has been absorbed by the gemstone 46. With that data, the system is able to determine whether the gemstone 46 is authentic. Other NBS's, i.e., non-scanning NBS's, may be used without departing from the invention. FIG. 7 shows the pusher member 42 and probe 52 in the retracted position, whereas FIG. 8 shows the pusher member 42 and probe 52 in the extended position where the NBS 50 is enabled to conduct its analysis.

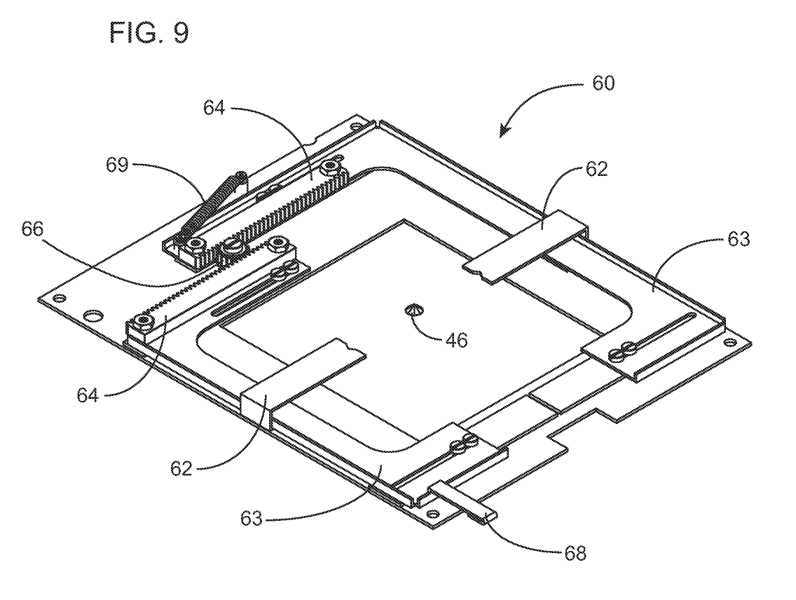

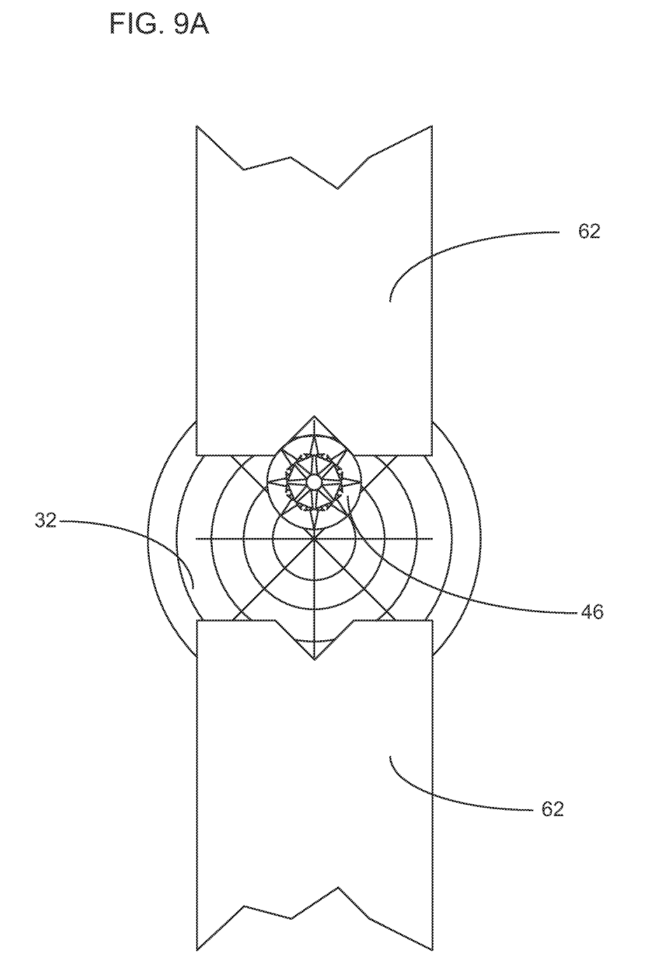

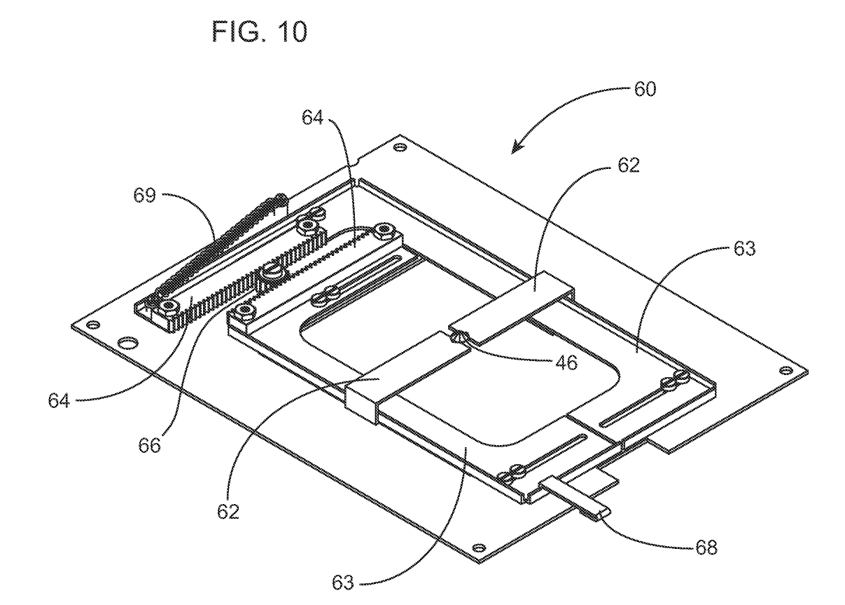

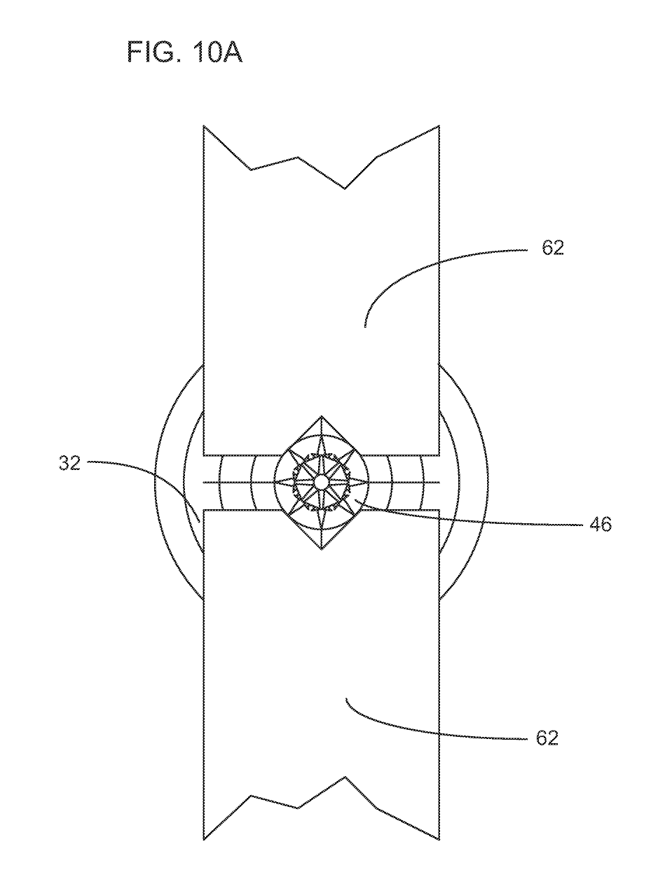

FIGS. 9-10 show an alternate two-pusher alignment device 60 that centers the gemstone 46 using two pushers 62. Each pusher 62 is connected to a frame 63, with each frame 63 having a toothed rack 64 on one end. The racks 64 engage a suitably toothed pinion 66 that, when rotated, moves the pushers 62 toward or away from the centerline. The two-pusher alignment device 60 may be operated manually or electrically by means of an external power source, such as an electric motor, connected to rotate the pinion in one direction or another. To manually operate the two-pusher alignment device 60, an operator manipulates a thumb lever 68 that extends from one of the frames 63. A spring 69 is attached to one of the frames 63 and is adapted to bias the alignment device 60 in the open position. Thus, when an operator releases the thumb lever 68, the alignment device 60 automatically returns to the open position. If the two-pusher alignment device 60 is operated by means of an external power source, an automatic alignment system similar to that described in the previous embodiment may be utilized.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A gemstone positioning and analysis system for measuring characteristics of a gemstone comprising:
a cabinet;
a mounting plate mounted in the cabinet and having a series of markings including a centermost point, to facilitate centering the gemstone on the mounting plate; and
an alignment device including at least one linear pusher and adapted to automatically position the gemstone at the centermost point.

2. The gemstone positioning and analysis system of claim 1, wherein the alignment device includes a single pusher arm, the pusher arm being connected to a computer controlled linear actuator.

3. The gemstone positioning and analysis system of claim 1, wherein the alignment device includes two pusher arms, the pusher arms being manually manipulated using a rack and pinion.

4. The gemstone positioning and analysis system of claim 1, further including a narrow band spectrophotometer adapted to measure the light absorbency of the gemstone.

5. A gemstone analysis system for measuring characteristics of a gemstone comprising:
a mounting plate including a centermost point, for supporting the gemstone;
a narrow-band spectrophotometer adapted to measure the light absorbance of the gemstone;
a movable light source adapted to illuminate the gemstone from a plurality of angles;
a wide-band spectrophotometer adapted to record images of the gemstone; and
the wide-band spectrophotometer and narrow-band spectrophotometer further adapted to provide data to a computer system adapted to analyze the data and to output material characteristics of the gemstone.

6. The gemstone analysis system of claim 5, further including an alignment device, the alignment device including at least one linear pusher and adapted to automatically position the gemstone at the centermost point of the mounting plate.

7. A gemstone positioning and analysis system for measuring characteristics of a gemstone comprising:
a cabinet;
a clear mounting plate including a series of markings to facilitate centering the gemstone on the mounting plate;
an alignment device including at least one linear pusher in proximity to the clear mounting plate and capable of moving the gemstone on the mounting plate;
a camera adapted to record images of the gemstone; and
a control system adapted to use images of the gemstone from the camera and control the alignment device so as to automatically center the gemstone at the centermost point of the clear mounting plate.

8. The gemstone positioning and analysis system of claim 7 wherein the control system includes a computer system adapted to analyze the images from the camera and control the alignment device so as to automatically center the gemstone at the centermost point of the clear mounting plate.

9. The gemstone positioning and analysis system of claim 7, further including a narrow band spectrophotometer adapted to measure the light absorbency of the gemstone.

10. A gemstone positioning and analysis system for measuring characteristics of a gemstone comprising:
a cabinet including an analysis chamber adapted to receive the gemstone;
the analysis chamber having upper and lower hemispherical portions with a clear mounting plate between the hemispherical portions;
the hemispherical portions having reflective inner surfaces;
the lower hemispherical portion having an aperture at its lowermost point, the aperture adapted to allow light to pass into the analysis chamber;
the clear mounting plate including a series of markings to facilitate centering the gemstone within the analysis chamber;
an alignment device including at least one linear pusher and adapted to automatically center the gemstone at the centermost point of the clear mounting plate;
a movable light source adapted to illuminate the gemstone from a plurality of angles;
a camera adapted to record images of the gemstone; and
the camera further adapted to provide data to a computer system adapted to analyze the data and to output material characteristics of the gemstone.

11. The gemstone positioning and analysis system of claim 10, wherein the alignment device includes a single pusher arm, the pusher arm being connected to a computer controlled linear actuator.

12. The gemstone positioning and analysis system of claim 10, wherein the alignment device includes two pusher arms, the pusher arms being manually manipulated using a rack and pinion.

13. A gemstone positioning and analysis system for measuring characteristics of a gemstone comprising:
a cabinet including an analysis chamber adapted to receive the gemstone;
the analysis chamber having upper and lower hemispherical portions with a clear mounting plate between the hemispherical portions;
the hemispherical portions having reflective inner surfaces;
the lower hemispherical portion having an aperture at its lowermost point, the aperture adapted to allow light to pass into the analysis chamber;
the clear mounting plate including a series of markings to facilitate centering the gemstone within the analysis chamber;
an alignment device including at least one linear pusher and adapted to automatically center the gemstone at the centermost point of the clear mounting plate;
a narrow-band spectrophotometer adapted to measure the light absorbance of the gemstone;
a movable light source adapted to illuminate the gemstone from a plurality of angles;
a camera adapted to record images of the gemstone; and
the camera further adapted to provide data to a computer system adapted to analyze the data and to output material characteristics of the gemstone.

14. The gemstone positioning and analysis system of claim 13, wherein the alignment device includes a single pusher arm, the pusher arm being connected to a computer controlled linear actuator.

15. The gemstone positioning and analysis system of claim 13, wherein the alignment device includes two pusher arms, the pusher arms being manually manipulated using a rack and pinion.

16. A method for analyzing the material properties of a gemstone comprising the steps of:
placing a gemstone in an analysis chamber having a clear mounting plate for supporting the gemstone;
automatically aligning the gemstone to the centermost point of the clear mounting plate;
illuminating the analysis chamber and the gemstone from a plurality of angles;
recording images of the gemstone; and
using a computer system to analyze the images of the gemstone to determine certain material qualities and characteristics of the gemstone.

17. The method of claim 16, further comprising the step of analyzing the light absorbency of the gemstone using a narrow band spectrophotometer.

18. The method of claim 16, further comprising the step of automatically generating a report showing the qualities and characteristics of the gemstone.

19. The method of claim 16, further comprising the steps of:
using a camera to automatically detect the center of the gemstone and the centermost point of the clear mounting plate; and
automatically actuating a linear alignment device to align the center of the gemstone with the centermost point of the clear mounting plate.

20. A gemstone positioning and analysis system for measuring characteristics of a gemstone comprising:
a cabinet;
an analysis chamber mounted in the cabinet and having an aperture adapted to allow light to pass into the analysis chamber and having a center point;
a clear mounting plate positioned within the analysis chamber and having a series of markings including a center point;
a movable light source adapted to illuminate the gemstone from a plurality of angles via the aperture and having a center point;
the center points of the analysis chamber, the clear mounting plate and the movable light source being arranged substantially along a common center line;
a camera mounted within the cabinet and arranged so that its center line substantially coincides with the common center line, and adapted to record images of the gemstone;
the camera further adapted to provide data to a computer system adapted to analyze the data and to output material characteristics of the gemstone; and
an alignment device including at least one linear pusher adapted to automatically center the gemstone on the center line.
